(19) United States
(12) Patent Application Publication
(10) Pub. No.: US 2011/0070507 A1
(43) Pub. Date: Mar. 24, 2011

(54) Solid Oxide Fuel Cell Systems with Heat Exchanges

(76) Inventors: Longting He, Horseheads, NY (US); Scott Christopher Pollad, Big Flats, NY (US); Dell Joseph St Julien, Watkins, NY (US)

(21) Appl. No.: 12/993,370

(22) PCT Filed: May 20, 2009
(86) PCT No.: PCT/US09/03118

§ 371 Date: Nov. 18, 2010

(30) Foreign Application Priority Data
May 30, 2008 (US) 61130531

(51) Int. Cl. H01M 8/04

(52) U.S. Cl. 429/408; 429/435

(57) ABSTRACT

Disclosed are solid oxide fuel cell systems, and methods for reducing temperature distribution across electrolytes within solid oxide fuel cells (SOFC), and increasing overall system efficiency. In one embodiment, the SOFCs include preheating channels that are interposed between electrolyte electrode assemblies within SOFCs, to provide internal heat exchange. The fuel and/or air entering the SOFC can be preheated in the preheating channels, thereby reducing or eliminating the need for an external preheating system. The preheating channels also provide barriers between each electrolyte electrode assembly, which aids in isolating damage within a single fuel cell.

This application claims the benefit of priority to U.S. Patent Application Ser. No. 61/130,531, filed on May 30, 2008, the content of which is relied upon and incorporated herein by reference in its entirety.

This invention was made with Government support under Cooperative Agreement 70NANB4H3036 awarded by National Institute of Standards and Technology (NIST). The Government has certain rights in this invention.

### FIELD OF THE INVENTION

The present invention relates to solid oxide fuel cells and, more particularly, to systems and methods for managing the thermal energy produced by the electrochemical reactions within a reaction chamber.

### BACKGROUND

Recently, significant attention has been focused on fuel cells as clean energy sources capable of highly efficient energy conversion in an environmentally friendly manner. Solid oxide fuel cells (SOFC) are one type of fuel cell that work at very high temperatures, typically between 700° C. and 1000° C. Solid oxide fuel cells can have multiple geometries, but are typically configured in a planar geometry. In a conventional planar configuration, an electrolyte is sandwiched between a single anode electrode and a single cathode electrode. The sandwiched electrolyte is used as a partition between a fuel gas, such as hydrogen, which is supplied to a partition on the anode electrode side, and an air or oxygen gas, which is supplied to the partition on the cathode electrode side.

In a typical solid oxide fuel cell system, approximately one half of the kinetic energy of reactants, such as fuel and oxygen, is converted into electricity and the other half is converted to thermal energy, which causes a significant temperature increase within the SOFC system. In order to trigger fast electrochemical reactions, the reactants often must be heated to a high temperature. For example, in a system using a thin yttria-partially stabilized zirconia (3YSZ) electrolyte, the reactants have to be heated to approximately 725° C. to obtain an effective reaction. With such an initial temperature of reactants, the peak temperature within the fuel cell for a stoichiometric hydrogen-air system can rise to more than 1000° C.

The electrical and mechanical performance of fuel cells depends heavily on the operating temperature of the system. At high temperatures (such as about 1000° C. or more), serious issues may arise in the way of thermal mechanical stress and the melting of sealing materials within the solid oxide fuel cell system components. Furthermore, external heating is often needed to heat the reactants to their optimal reaction temperature, which results in low overall system efficiency.

Various thermal management strategies have been developed. For example, U.S. 2004/0170879A1 discloses a shape memory alloy structure that is connected to a fuel cell for thermal management. U.S. 2005/0014046A1 discloses an internal bipolar heat exchanger that is used to remove the heat from an anode side of an individual cell to heat the cathode flow of another cell. In U.S. 2004/0028972A1, a fluid heat exchanger is disclosed for transferring heat between fuel cell units and a heat exchanger fluid flow, which flows in a direction perpendicular to the electrolyte surface. Further, in U.S. 2003/017695A1, a reformer reactor is disclosed that is connected to a fuel cell for helping the thermal management at the system level. In WO2003065488A1, an internal reformer is disclosed for use in thermal management of a fuel cell.

Accordingly, there is a need in the art for thermal management systems and methods that are able to both reduce the thermal mechanical stress that results from the thermal energy generated in the reaction and preheat the reactants that enter the reaction chamber increase the overall system efficiency of the solid oxide fuel cell

### SUMMARY

The present invention relates to embodiments of stack designs for solid oxide fuel cell (SOFC) systems exhibiting high efficiency and a relatively narrow distribution of operating temperature across the electrolyte of the SOFC.

According to one exemplary embodiment, A modular solid oxide fuel cell system, comprises: (i) a housing; (ii) at least one modular fuel cell packet comprising:

a fuel cell frame; a first electrode assembly comprising a first planar electrolyte sheet having a plurality of anodes disposed on a first surface of the first electrolyte sheet and a plurality of cathodes disposed on an opposed second surface of the first electrolyte sheet; and a second electrode assembly comprising a second planar electrolyte sheet having a plurality of anodes disposed on a first surface of the second electrolyte sheet and a plurality of cathodes disposed on an opposed second surface of the second electrolyte sheet, wherein the fuel cell frame supports the first and second electrode assemblies such that the respective first and second electrode assemblies are separated from one another and such that the respective first surfaces of the respective first and second electrolyte sheets face each other and define an anode chamber, wherein the fuel cell frame further defines a fuel inlet in fluid communication with the anode chamber; and (iii) a plurality of modular oxidant heat exchange packets, each heat exchange packet comprising a body having a pair of opposed, spaced side walls, wherein the body further defines an interior volume, an oxidant inlet in communication with the interior volume, and at least one outlet in communication with the interior volume,

wherein the housing supports the at least one modular fuel cell packet and the plurality of modular heat exchange packets, wherein a pair of modular heat exchange packets of the plurality of modular heat exchange packets are positioned in spaced opposition and define an oxidant chamber therebetween, wherein one modular fuel cell packet of the at least one modular fuel cell packet is positioned within the oxidant chamber in spaced relation to the pair of modular heat exchange packets; and wherein the outlet of the pair of modular heat exchange packets is in fluid communication with the oxidant chamber.

In one example, the SOFC systems comprise preheating chambers that are interposed between active SOFC packets, such as planar electrolyte electrode assemblies within SOFCs, to provide internal heat exchange, which reduces or eliminates the need for an inefficient external preheating system. By utilizing a portion of the thermal energy generated within an electrochemical reaction chamber to preheat air and/or fuel entering the fuel cell, the overall system efficiency can be significantly increased. Further, preheating the air allows for a reduced flow rate, which also increases the system efficiency and reliability. The preheating channels can also act as barriers between each single fuel cell packet, which aids in isolating damage within a single fuel cell device.

In one exemplary embodiment, the present invention provides a modular solid oxide fuel cell system comprising a housing, at least one modular fuel cell packet, and a plurality of modular oxidant heat exchange packets. In a further embodiment, the at least one modular fuel cell packet comprises a fuel cell frame, a first electrode assembly comprising a first planar electrolyte sheet having a plurality of anodes disposed on a first surface of the first electrolyte sheet and a plurality of cathodes disposed on an opposed second surface of the first electrolyte sheet, and a second electrode assembly comprising a second planar electrolyte sheet having a plurality of anodes disposed on a first surface of the second electrolyte sheet and a plurality of cathodes disposed on an opposed second surface of the second electrolyte sheet. The fuel cell frame can support the first and second electrode assemblies such that they are separated from one another and such that the respective first surfaces of the first and second electrolyte sheets face each other and define an anode chamber. The fuel cell frame can further define a fuel inlet in fluid communication with the anode chamber.

In yet a further exemplary embodiment, the housing can support the at least one modular fuel cell packet and the plurality of modular heat exchange packets. The pair of modular heat exchange packets can be positioned in spaced opposition and define an oxidant chamber therebetween. A modular fuel cell packet can be positioned within the oxidant chamber in spaced relation to the pair of modular heat exchange packets. According to yet another embodiment, the outlet of the pair of modular heat exchange packets is in fluid communication with the oxidant chamber

In another exemplary embodiment, the present invention provides a method for generating electrical power that comprises providing a modular solid oxide fuel cell system comprising a housing, at least one modular fuel cell packet, and a plurality of modular oxidant heat exchange packets. The method can further comprise positioning at least two of the plurality of modular oxidant heat exchange packets within the housing in spaced relation to each other and positioning one of the at least one modular fuel cell packets within the housing and in between the at least two modular oxidant heat exchange packets. In a particular embodiment, the at least one modular fuel cell packets is in spaced relation to each of the at least two modular oxidant heat exchange packets. In a further embodiment, the method comprises supplying an oxidant stream to the oxidant inlet of at least one of the modular oxidant heat exchange packets, and supplying a fuel stream to the fuel inlet of the at least one modular fuel cell packet. In yet a further embodiment, the method comprises using thermal energy generated by the at least one fuel cell packet to preheat the oxidant stream.

Additional embodiments of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed and/or as claimed.

### BRIEF DESCRIPTION OF THE DRAWINGS

The accompanying drawings, which are incorporated in and constitute a part of this specification, illustrate certain aspects of the instant invention and together with the description, serve to explain, without limitation, the principles of the invention.

FIG. 1 is a cut-away view of a modular solid oxide fuel cell system within an operating environment, according to one embodiment of the present invention.

FIG. 2A illustrates a fuel cell frame of a modular fuel cell packet, according to another embodiment of the present invention.

FIG. 2B is a cross-sectional view of Section A-A of the fuel cell packet frame of FIG. 2A.

FIG. 3 illustrates a modular fuel cell packet, according to one embodiment of the present invention.

FIG. 4 illustrates a side wall of a modular oxidant heat exchange packet, according to other embodiment of the present invention.

FIG. 5 is a perspective, cross-sectional view of a modular solid oxide fuel cell system with modular oxidant heat exchange packets arranged therein, according to one exemplary embodiment of the present invention.

FIG. 6 is a perspective, cross-sectional view of a modular solid oxide fuel cell system with modular fuel cell packets and modular heat exchange packets arranged therein, according to another exemplary embodiment of the present invention.

FIG. 7 illustrates oxidant and fuel flow within a modular solid oxide fuel cell.

### DETAILED DESCRIPTION OF THE INVENTION

The following description of the invention is provided as an enabling teaching of the invention in its best, currently known embodiment. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to an “oxidant preheating chamber” includes embodiments having two or more such “oxidant preheating chambers” unless the context clearly indicates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As briefly summarized above, the present invention provides systems and methods for managing temperature distribution within a modular solid oxide fuel cell device, and increasing overall system efficiency. These systems and methods can, in various embodiments, increase the efficiency of a solid oxide fuel cell system by utilizing thermal energy produced in reactions within the fuel cell device to preheat air and/or fuel gases entering the fuel cell device, thereby reducing and/or eliminating the need for an external preheating system.

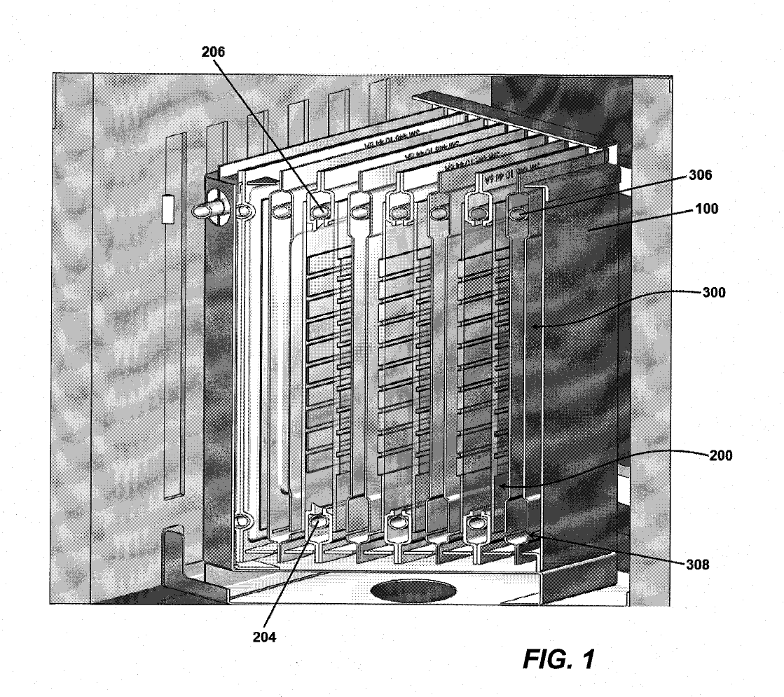

According to various embodiments of the present invention and as illustrated in FIG. 1, for example, a modular solid oxide fuel cell system 10 comprises a housing 100, at least one modular fuel cell packet 200, and at least one modular oxidant heat exchange packet 300. As illustrated in FIG. 1, a plurality of modular fuel cell packets 200 and a plurality of modular oxidant heat exchange packets 300 can be arranged within the housing 100 in an alternating array of fuel cell packets and oxidant heat exchange packets. Thus, in one particular embodiment, the fuel cell packets and heat exchange packets can be arranged such that each fuel cell packet is positioned in between two heat exchange packets. Therefore, in this configuration, a minimum number of packets are 1 fuel cell packet, and 2 heat exchange packets. The maximum number of packets is determined by the amount of output power required from the solid oxide fuel cell system.

Each fuel cell packet 200 incorporates a hermetically isolated fuel chamber situated inside the fuel cell packet that is formed between the two fuel cell devices (also referred to an electrode assemblies herein). More specifically, a fuel cell packet 200, according to various embodiments, can comprise a fuel cell packet frame 202 and at least one electrode assembly (i.e., a fuel cell device) 210. In the embodiment shown in FIG. 1, each fuel cell device 210 is a multi-cell device—i.e., each fuel cell device 210 comprises a plurality of arrayed fuel cells. In this particular embodiment, each fuel cell device is a planar, electrolyte supported fuel cell array.

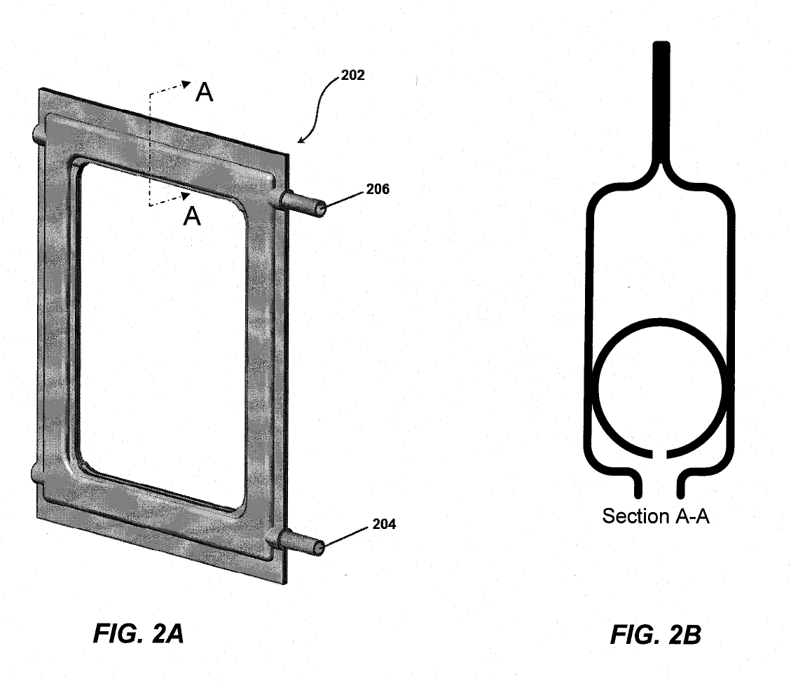

An exemplary fuel cell packet frame 202 is illustrated in FIGS. 2A and 2B. The fuel cell frame can be made of substantially rectangular stamped sheets of various materials. The fuel cell frame may be manufactured, for example, from stainless steel sheets 203, such as E-bright, or 446-stainless steel. Alternatively, a fuel cell frame may be made from glass, glass ceramic, fully or partially stabilized zirconia. Preferably, the coefficients of thermal expansion (CTE) of the frame material is close to that of the or the electrolyte material. (E.g., the CTE difference between the frame and the electrolyte materials is within 1×10−6 cm/cm/° C., preferably, 0.6×10−6 cm/cm/° C., more preferably 0.4×10−6 cm/cm/° C.) For example, each frame can be manufactured as a sheet and can have a substantially rectangular aperture 202A defined therein the inner portion of the sheet; thus, each sheet can define an inner periphery and an outer periphery. The sheet can be stamped, for example, in the portion of the sheet lying between the inner periphery and outer periphery, such as to form a well. As shown in FIG. 2B, the well can be shaped such that when the sheets 203 are adjoined, face-to-face, they make substantially full contact along portions of the outer periphery, but are at a spaced distance from each other along portions of the inner periphery. A fuel inlet 204 can be in fluid communication with the well formed in the lower portion of the fuel cell frame, such as shown in FIG. 2A. Similarly, a fuel outlet 206 can be in fluid communication with the well formed in the upper portion of the fuel cell frame.

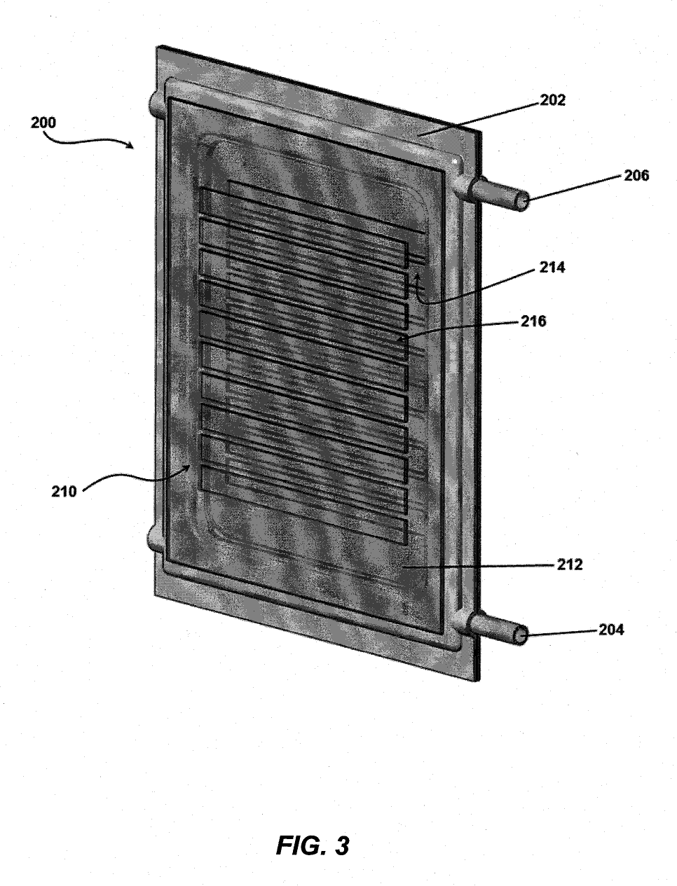

A fuel cell packet 200, according to further embodiments, can comprise at least one fuel cell device 210 (also referred to as electrode assembly herein). With reference to FIG. 3, an electrode assembly can comprise an electrolyte sheet 212 that can be a substantially planar sheet with a first surface and an opposing second surface. A plurality of anodes 214 can be disposed on the first surface and a plurality of cathodes 216 can be disposed on the opposed second surface, forming a multi-cell fuel cell device. A second electrode assembly can be similarly formed. In one embodiment, the fuel cell frame 202 can support the first and second electrode assemblies 210 such that the first and second electrode assemblies (i.e., fuel cell devices) 210 are separated from one another at a spaced distance. In a further embodiment, the first and second electrode assemblies 210 are supported by the frame 202 such that the respective first surfaces of the first and second electrode assemblies 210 face each other and define an anode chamber 220 (i.e., fuel chamber). As described above, the fuel cell frame 202 can be formed of a stamped material (or, alternatively, can be made from glass or glass ceramic) in such a manner that portions of the sheets of the fuel cell frame are at a spaced distance d from each other along the inner periphery. This distance d made be, for example, 0.5 mm or more. A typical distance may be, for example 1 mm to 7 mm. In this manner, there can be fluid communication from the fuel inlet 204, through the well formed in the lower portion of the fuel cell frame, and into the anode chamber (also referred to as a fuel chamber herein). Likewise, there can be fluid communication from the anode chamber, through the well formed in the upper portion of the fuel cell frame, and to the fuel outlet 206 of the fuel cell packet 200.

According to an embodiment of the present invention the direction of fuel flow in the fuel cell packets 200 is substantially in the direction of gravity. The frames 202 of fuel cell packets may be fabricated, for example, from formed stainless steel alloy with a wall thickness of no more than 1 mm, for example 0.25 mm-1 mm.

In one embodiment, the plurality of cathodes react 216 with an oxidant, such as oxygen-containing air, to produce oxygen ions. The plurality of anodes 214 use the oxygen ions produced by the cathode 216 to react with fuel (such as, but not limited to, hydrogen gas) to produce water and electricity. The electrolyte sheet 212 acts as a membrane or barrier, separating the oxidant on the cathode side from the fuel on the anode side. In this configuration, the electrolyte sheet 212 can also serve as an electrical insulator that prevents electrons resulting from the oxidation reaction on the anode side from reaching the cathode side. In a further embodiment, the electrolyte sheet 212 can be configured to conduct the oxygen ions, produced by the cathodes 216, to the anodes 214.

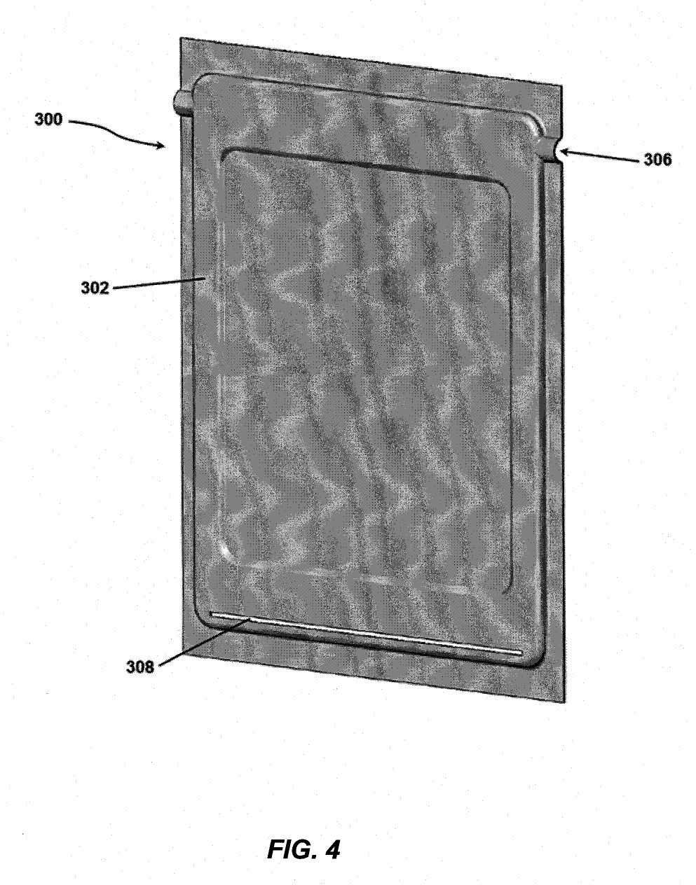

A modular solid oxide fuel cell system, according to some embodiments, further comprises a plurality of modular oxidant heat exchange packets 300. A modular oxidant heat exchange packet can comprise a body having a pair of opposed, spaced side walls 302 that are respectively positioned to define an interior volume 301 (i.e., air chamber), also referred to as a heat exchange cavity herein. FIG. 4 illustrates a side wall 302 of an exemplary modular oxidant heat exchange packet 300. The walls 302 of the modular oxidant heat exchange packet may be manufactured, for example, from stainless steel such as E-bright, or 446 stainless steel, or a nickel alloy, or may be made from glass, glass ceramic, fully or partially stabilized zirconia. The walls 302 may be fabricated from formed stainless steel alloy with a thickness not greater than 1 mm. The walls 302 may be formed, for example, from formed stainless steel alloy with a wall thickness of no more than 1 mm, for example 0.1 mm to 1 mm. The walls 302 of the heat exchange packets 300 may comprise two formed alloy structures (walls) that abut each other, but not constrained such that each stamp/form can slip relative to each other under conditions of thermal gradients.

As can be seen, a portion of the side walls can be formed to define an oxidant inlet 306 in communication with the interior volume (internal air chamber) 301, which serves as an oxidant preheating chamber (i.e., heat exchange chamber). The side walls 302 can further define at least one outlet 308 in communication with the interior volume 301. In a particular embodiment (see FIG. 4), the outlet is a substantially horizontal slit defined in the lower portion of the side wall 302. In another embodiment the oxidant outlet 308 is similar in shape to the oxidant inlet 306. The heat exchange packets 300 do not need to be hermetically sealed, and do not need to be CTE matched to the fuel cell devices.

The heat exchange packets 300 may be comprised of a frame and two planar electrolyte sheets, the electrolyte sheets being arranged substantially parallel to one another, such that the cavity between them defines a an internal air chamber 301 that serves as an oxidant *(air) heat exchange chamber.

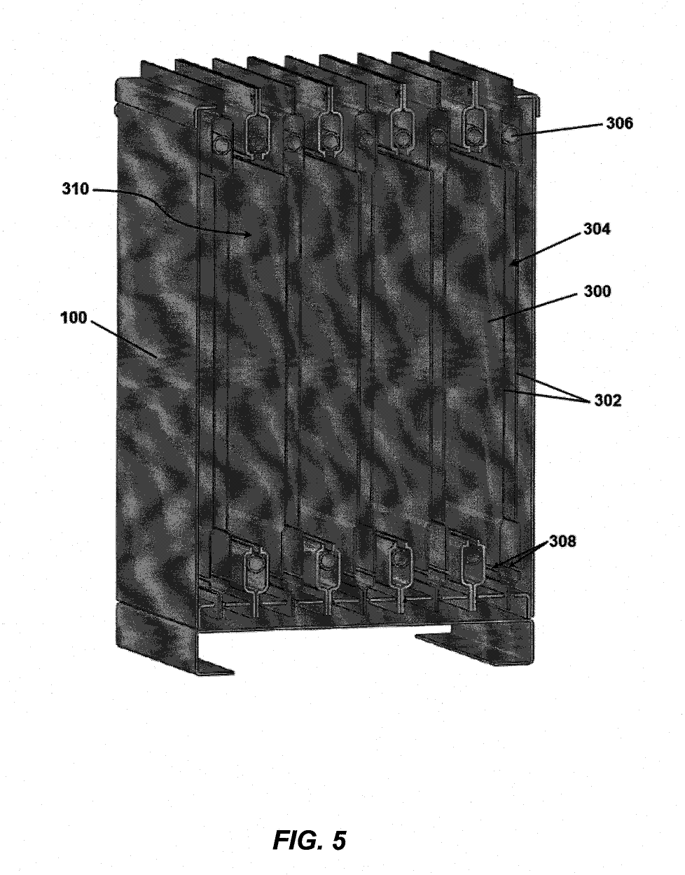

As illustrated in FIG. 5, a plurality of modular oxidant heat exchange packets 300 can be supported by the housing 100. In one embodiment, at least two heat exchange packets 300 can be positioned within the housing 100 in spaced opposition with each other, to define an oxidant chamber 310 therebetween. In a particular embodiment, the modular oxidant heat exchange packets 300 are positioned substantially vertically within the housing, such as shown in FIG. 5.

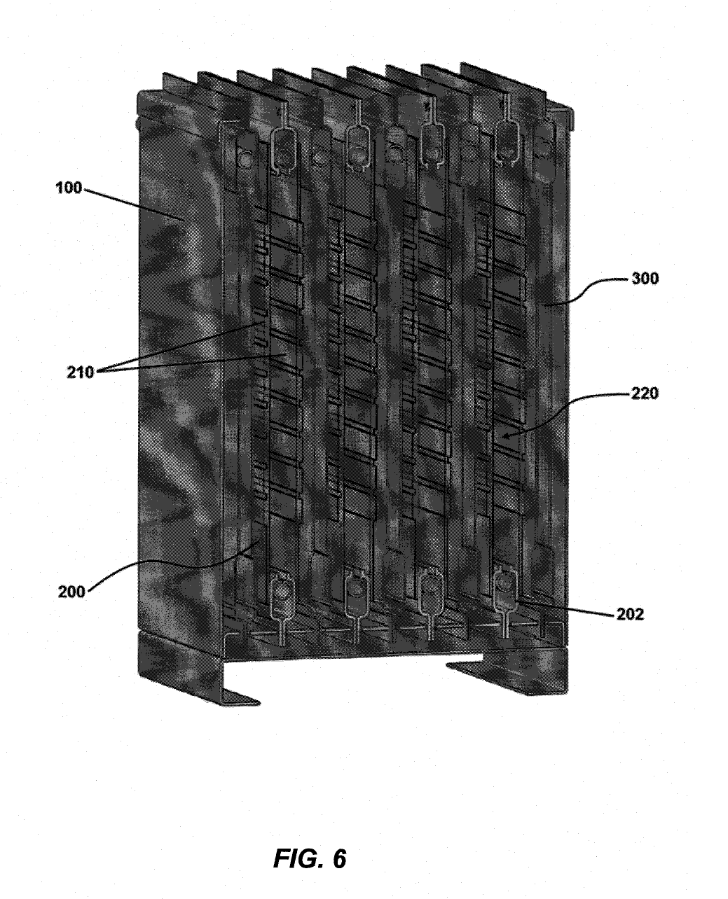

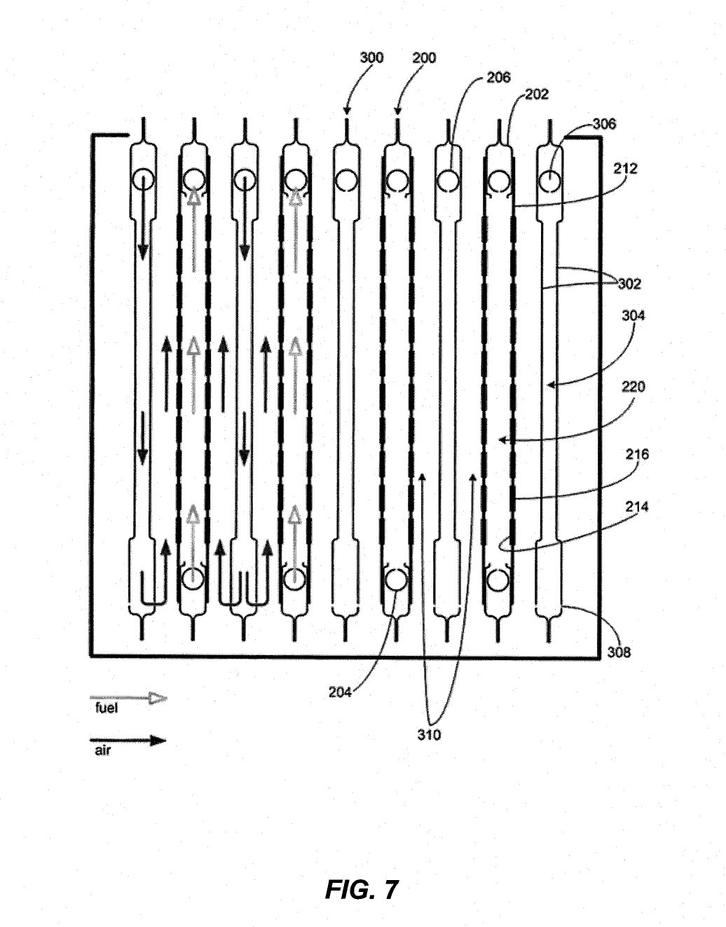

The housing 100 can similarly support at least one modular fuel cell packet, such as shown in FIGS. 6 and 7. In a particular embodiment, the at least one modular fuel cell packet 200 is positioned in between and in spaced relation to a pair of modular oxidant heat exchange packets 300 (e.g., within the oxidant chamber 310), thus forming cathode reaction chamber(s) 310A situated between the walls of the fuel cell packets 200 and the walls of the heat exchange packets 300. That is, the heat exchange packet 300 faces the cathode side(s) of the fuel cell devices 210 of the modular fuel cell packets 200. Spaces (wall to wall) between adjacent packets may be, for example, of about 0.5 mm to 7 mm, more preferably 1 mm to 5 mm. According to various embodiments, a modular solid oxide fuel cell device can comprise “n” fuel cell packets and “n+1” modular oxidant heat exchange packets. For example, a modular solid oxide fuel cell device can comprise one (1) modular fuel cell packets and two (2) modular oxidant heat exchange packets. In another embodiment, “n” can be at least two (2), such that a modular solid oxide fuel cell device can comprise at least two (2) modular fuel cell packets and at least three (3) modular oxidant heat exchange packets. It is contemplated that, according to various embodiments, a modular solid oxide fuel cell can comprise any number of modular fuel cell packets and any number of modular oxidant heat exchange packets and is not intended to be limited to the specific numbers referred to herein.

FIG. 7 illustrates schematically the exemplary flow of an oxidant, such as air, and fuel within a modular solid oxide fuel cell system that utilizes heat exchange packets similar to that shown in FIG. 4A. As illustrated, air enters the device via the oxidant inlet 306 of at least one of the modular oxidant heat exchange packets 300. In this embodiment, the air flows downwardly (i.e., in direction of gravity) through the heat exchange packet (i.e., through the interior volume 301 formed therein) and exits the oxidant chamber via the outlet 308. The air then passes through the oxidant chamber 310 (and thus through the cathode reaction chamber 310A) along the cathode side or surface of the modular fuel cell packet positioned next to the heat exchange packet. As described above, the air or oxidant reacts with the cathodes 216 to produce oxygen ions, which are conducted through the electrolyte sheet 212 to the anode side or surface. Fuel, such as but not limited to hydrogen gas, enters the modular fuel cell packet 200, specifically into the anode chamber 220, via the fuel inlet 204. The fuel reacts with the oxygen ions at the anodes to form water and electricity. The products of this reaction (e.g., exhaust gas) exit the anode chamber via the outlet 206.

As illustrated in FIG. 7, with respect to a modular heat exchange packet 300 that is positioned between two modular fuel cell packets 200 (the air passing through the interior volume 304 of the heat exchange packet can exit via the outlets 308 defined in each side wall 302 of the respective heat exchange packet. In this manner, air can pass through the oxidant chamber 310 along the cathode side of each of the fuel cell packets 200 that faces the respective heat exchange packet 300. Thus, the walls of the fuel cell packet 200 and the walls of the adjacent respective heat exchange packets (oxidant heat exchange packets) 300 provide, in part, cathode reaction chambers 310A in which air flows between the walls of the fuel cell packet 200 and the walls of the adjacent respective heat exchange packets 300. The heat exchange packets 300 help control and/or minimize thermal gradients within the fuel cell packet(s) 200 and the fuel cell stack by transferring thermal energy generated by the fuel cell packet(s) 200 to cooler air within the heat exchange packets oxidant heat exchange packet(s) 300, for example by utilizing a radiant susceptor and spreader. That is, the walls of the heat exchange packets act as radient susceptors by radiant heat absorption, and then spread the heat and provide it to the oxidant inside the interior volume 301 of the heat exchange packets 300. For example, the heat is:
(i) first radiantly transferred from the fuel cell packet (the heat is generated along the electrolyte sheets of the modular fuel cell packets by the reaction of the fuel with the oxygen ions) to the air situated between the fuel cell packet(s) 200 and the heat exchange packet(s) 300—i.e., to the air within the oxidant chamber along the cathode side of each of the fuel cell packet(s) that faces the respective heat exchange packet;
(ii) conductively spread throughout the wall surface of the heat exchange packet(s) 300; and then
(iii) finally transferred to the incoming air via convection and/or gas phase conduction.

In the exemplary embodiment shown in FIG. 7, the air (or fuel in an alternate embodiment not described herein) is first preheated in by the heat release from the electrode assembly 210. The heat is first radiantly transferred from the fuel cell devices 210 or the side walls of the fuel packet(s) 200 to the alloy wall surface(s) of the heat exchange packet(s) 300, then is conductively spread throughout the walls of the heat exchange packet(s) 300, and finally transferred to the incoming air via convection and to a lesser extent gas phase conduction. Preferably, the temperature gradient can be maintained within 50° C., more preferably within 35° C., and most preferably within 25° C.

According to various embodiments, the oxidant must be at a predetermined temperature in order to react with the cathodes, or in order to allow for a faster and/or more efficient electrochemical reaction with the cathodes. According to other embodiments, the fuel may also need to be at a predetermined temperature in order to react with the oxygen ions to produce the electricity. In one embodiment, the predetermined temperature of the supplied fuel, air, or both, can be any temperature greater than 600° C., such as approximately 600° C.-1000° C. Optionally, the predetermined temperature of the fuel, air, or both, can be in the range of from about 650° C. to about 900° C., preferably 700° C. to about 900° C., or 650° C.-800° C.

In a particular embodiment, the air or oxidant that is initially provided to the modular fuel cell system can be preheated to a specific predetermined temperature. Optionally, heat is generated along the electrolyte sheets 212 of the modular fuel cell packets 200 by the reaction of the fuel with the oxygen ions. The thermal energy produced can be conducted through the side walls of each of the modular heat exchange packets 300 to preheat the air passing therethrough. Thus, in one embodiment, the modular heat exchange packets 300 can be comprised of a material having a predetermined thermal conductivity. Therefore, in one embodiment, the thermal energy that is produced by the reactions of the fuel cell packets can be used to preheat the oxidant, which is needed to produce the reactions. As described above, the oxidant can be preheated by an external preheating means in order to initially start the process. However, it is contemplated that upon an initial reaction at a fuel cell packet 200, the modular solid oxide fuel cell system can be substantially self-sustaining without the need for external heating means for either the oxidant or the fuel or both. Thus, once an initial reaction has occurred within the modular solid oxide fuel cell system, relatively cooler air can be brought into the fuel cell system via the inlets of the heat exchange packets 300, and this air can be progressively heated as it passes therethrough and can reach the necessary predetermined temperature by the time that the air passes along and reacts with the cathodes 216.

As may be appreciated by one skilled in the art, as the reactions occur within the modular solid oxide fuel cell system 10, the components therein will endure thermal expansion and/or contraction. In one embodiment, due to the spatial separation between each of the modular heat exchange packets 300 and each of the modular fuel cell packets 200, each of the packets can expand at varying rates without interfering with the other packets. In one embodiment, for example, the modular heat exchange packets have walls that can comprise a material having a higher coefficient of thermal expansion (CTE) than that of the frame of the modular fuel cell packets, for instance. Thus, the modular heat exchange packets may experience larger thermal gradients than those experienced by the fuel cell packets, and thus can move independently of the fuel cell packets and avoid interfering therewith

It should be understood that while the present invention has been described in detail with respect to certain illustrative and specific embodiments thereof, it should not be considered limited to such, as numerous modifications are possible without departing from the broad spirit and scope of the present invention as defined in the appended claims.

What is claimed:

1. A modular solid oxide fuel cell system, comprising:
a housing;
at least one modular fuel cell packet comprising:
a fuel cell frame;
a first electrode assembly comprising a first planar electrolyte sheet having a plurality of anodes disposed on a first surface of the first electrolyte sheet and a plurality of cathodes disposed on an opposed second surface of the first electrolyte sheet; and
a second electrode assembly comprising a second planar electrolyte sheet having a plurality of anodes disposed on a first surface of the second electrolyte sheet and a plurality of cathodes disposed on an opposed second surface of the second electrolyte sheet,
wherein the fuel cell frame supports the first and second electrode assemblies such that the respective first and second electrode assemblies are separated from one another and such that the respective first surfaces of the respective first and second electrolyte sheets face each other and define an anode chamber, wherein the fuel cell frame further defines a fuel inlet in fluid communication with the anode chamber; and
a plurality of modular oxidant heat exchange packets, each heat exchange packet comprising a body having a pair of opposed, spaced side walls, wherein the body further defines an interior volume, an oxidant inlet in communication with the interior volume, and at least one outlet in communication with the interior volume,
wherein the housing supports the at least one modular fuel cell packet and the plurality of modular heat exchange packets, wherein a pair of modular heat exchange packets of the plurality of modular heat exchange packets are positioned in spaced opposition and define an oxidant chamber therebetween, wherein one modular fuel cell packet of the at least one modular fuel cell packet is positioned within the oxidant chamber in spaced relation to the pair of modular heat exchange packets; and wherein the outlet of the pair of modular heat exchange packets is in fluid communication with the oxidant chamber.

2. The modular solid oxide fuel cell system of claim 1, comprising “n” fuel cell packets and “n+1” modular oxidant heat exchange packets, wherein “n” is at least 2.

3. The modular solid oxide fuel cell system of claim 1, wherein the pair of opposed, spaced side walls are in radiant thermal communication with heat emitted from the at least one modular fuel cell packet and wherein the pair of opposed, spaced side walls preheat oxidant flowing through the interior volume of the heat exchange packet.

4. The modular solid oxide fuel cell system of claim 1, wherein the plurality of modular heat exchange packets comprise stamped metal.

5. The modular solid oxide fuel cell system of claim 1, wherein each of the modular heat exchange packets and the at least one modular fuel cell packet are positioned in spaced opposition of at least 0.75 inches.

6. A method for generating electrical power, comprising:
providing a modular solid oxide fuel cell system comprising:
a housing;
at least one modular fuel cell packet comprising a fuel cell frame, a first electrode assembly comprising a first planar electrolyte sheet having a plurality of anodes disposed on a first surface of the first electrolyte sheet and a plurality of cathodes disposed on an opposed second surface of the first electrolyte sheet, and a second electrode assembly comprising a second planar electrolyte sheet having a plurality of anodes disposed on a first surface of the second electrolyte sheet and a plurality of cathodes disposed on an opposed second surface of the second electrolyte sheet, wherein the fuel cell frame supports the first and second electrode assemblies such that the respective first and second electrode assemblies are separated from one another and such that the respective first surfaces of the respective first and second electrolyte sheets face each other and define an anode chamber, wherein the fuel cell frame further defines a fuel inlet in fluid communication with the anode chamber; and
a plurality of modular oxidant heat exchange packets, each heat exchange packet comprising a body having a pair of opposed, spaced side walls, wherein the body further defines an interior volume, an oxidant inlet in communication with the interior volume, and at least one outlet in communication with the interior volume;
positioning at least two of the plurality of modular oxidant heat exchange packets within the housing in spaced relation to each other;
positioning one of the at least one modular fuel cell packets within the housing and in between the at least two modular oxidant heat exchange packets, wherein the at least one modular fuel cell packets is in spaced relation to each of the at least two modular oxidant heat exchange packets;
supplying an oxidant stream to the oxidant inlet of at least one of the modular oxidant heat exchange packets; and
supplying a fuel stream to the fuel inlet of the at least one modular fuel cell packet.

7. The method of claim 6, wherein the oxidant stream passes through the interior volume of the at least one modular oxidant heat exchange packet, through the outlet of the at least one modular oxidant heat exchange packet, into the oxidant chamber defined therebetween the at least one modular oxidant heat exchange packet and the at least one modular fuel cell packet, and wherein the fuel stream passes through the fuel inlet into the anode chamber of the at least one modular oxidant heat exchange packet, the method further comprising generating an electrochemical reaction along at least the electrolyte sheet in communication with the oxidant chamber defined therebetween the at least one modular oxidant heat exchange packet and the at least one modular fuel cell packet.

8. The method of claim 7, wherein the electrochemical reaction generates thermal energy, the method further comprising thermally communicating at least a portion of the thermal energy to the at least one modular heat exchange packet.

9. The method of claim 8, further comprising preheating the oxidant stream to a predetermined temperature using at least a portion of the thermal energy communicated to the at least one modular heat exchange packet.

10. The method of claim 9, wherein the predetermined temperature is greater than 700° C.

11. The method of claim 9, wherein the predetermined temperature is in the range of 700° C. to 800° C.

12. The method of claim 6, further comprising preheating the oxidant stream prior to supplying the oxidant stream to the oxidant inlet.

13. The method of claim 6, wherein the oxidant comprises oxygen-containing air.

14. The method of claim 6, wherein the fuel comprises hydrogen gas.

15. The method of claim 6, wherein the modular solid oxide fuel cell system comprises “n” fuel cell packets and “n+1” modular oxidant heat exchange packets and wherein “n” is at least 2.
